(19) United States
(12) Patent Application Publication
(10) Pub. No.: US 2016/0343012 A1
(43) Pub. Date: Nov. 24, 2016

(54) GENERATING A PROFILE OF A GEOGRAPHIC AREA BASED ON PAYMENT TRANSACTION DATA

(71) Applicant: MASTERCARD INTERNATIONAL INCORPORATED, PURCHASE, NY (US)

(72) Inventors: Loralee J. Bodo, Hawthorne, NY (US); Annmarie Swingle, New York, NY (US); Giulio Leccisotti, Madrid (SP)

(21) Appl. No.: 14/717,689

(22) Filed: May 20, 2015

(51) Int. Cl. G06Q 30/02

(52) U.S. Cl. CPC G06Q 30/0205

(57) ABSTRACT

A profile generation computing device for generating a profile of a predefined geographic area is provided. Additionally, a method and a computer-readable storage medium having computer-executable instructions embodied thereon for generating a profile of a predefined geographic area are provided.

### BACKGROUND

This disclosure relates to processing electronic signals associated with a payment network, and more specifically to generating a profile of a geographic area based at least in part on purchases made by residents of the geographic area through a payment network.

When a person unfamiliar with a particular geographic area, such as a potential home buyer, a renter, a landlord, or a merchant seeks information about the area, different types of information about the area are distributed across multiple different sources, and it is difficult to obtain an overall impression of the area. Potential residents tend to desire living near other people with similar socioeconomic statuses and interests. Additionally, merchants benefit from establishing locations in areas in which their customers are located. Accordingly, if a merchant establishes a location in a neighborhood that does not have customers who are interested in and financially able to purchase goods from the merchants, then the merchants may struggle financially. However, information about what the residents of an area are purchasing from merchants local to the area is not readily available. That is, while a source of information may indicate that a particular type of merchant, such as a gourmet restaurant, is located in a neighborhood, information about whether the merchant is receiving business from the residents of the neighborhood is difficult to obtain. Moreover, while realtors familiar with the area may have formed an opinion of the area, they are prevented by regulations from sharing certain opinions and information, such as socioeconomic profiles of the residents, with potential buyers or renters of real estate in the geographic area.

### BRIEF DESCRIPTION OF THE DISCLOSURE

In one aspect, a profile generation computing device for generating a profile of a predefined geographic area is provided. The profile generation computing device includes a processor coupled to a memory. The profile generation computing device is in communication with a payment processing network and is configured to receive at least one transaction record signal including records of a plurality of financial transactions processed by the payment processing network for a plurality of merchants within a predefined geographic area. Additionally, the profile generation computing device identifies categories of goods purchased by a plurality of cardholders from the merchants in the predefined geographic area based on the plurality of financial transactions. Further, the profile generation computing device determines that a subset of the cardholders are residents of the predefined geographic area based at least in part on determining that a subset of the cardholders purchased goods from the merchants in the predefined geographic area at a frequency that is at least equal to a reference frequency. Additionally, the profile generation computing device determines an estimated average socioeconomic status of the residents based on the categories of goods and generates a profile of the predefined geographic area. The profile includes at least the estimated average socioeconomic status of the residents.

In another aspect, a method for generating a profile of a predefined geographic area is provided. The method is implemented by a profile generation computing device in communication with a payment processing network. The profile generation computing device includes one or more processors in communication with a memory. The method includes receiving, by the profile generation computing device, at least one transaction record signal including records of a plurality of financial transactions processed by the payment processing network for a plurality of merchants within a predefined geographic area. The method additionally includes identifying, by the profile generation computing device, categories of goods purchased by a plurality of cardholders from the merchants in the predefined geographic area based on the plurality of financial transactions. Further, the method includes determining, by the profile generation computing device, that a subset of the cardholders are residents of the predefined geographic area based at least in part on determining that a subset of the cardholders purchased goods from the merchants in the predefined geographic area at a frequency that is at least equal to a reference frequency. The method also includes determining, by the profile generation computing device, an estimated average socioeconomic status of the residents based on the categories of goods and generating, by the profile generation computing device, a profile of the predefined geographic area. The profile includes at least the estimated average socioeconomic status of the residents.

In yet another aspect, a computer-readable storage medium having computer-executable instructions embodied thereon is provided. When executed by a profile generation computing device coupled to a payment network and having at least one processor coupled to a memory, the computer-executable instructions cause the profile generation computing device to receive at least one transaction record signal including records of a plurality of financial transactions processed by the payment processing network for a plurality of merchants within a predefined geographic area. The instructions additionally cause the profile generation computing device to identify categories of goods purchased by a plurality of cardholders from the merchants in the predefined geographic area based on the plurality of financial transactions, determine that a subset of the cardholders are residents of the predefined geographic area based at least in part on determining that a subset of the cardholders purchased goods from the merchants in the predefined geographic area at a frequency that is at least equal to a reference frequency, determine an estimated average socioeconomic status of the residents based on the categories of goods, and generate a profile of the predefined geographic area. The profile includes at least the estimated average socioeconomic status of the residents.

### BRIEF DESCRIPTION OF THE DRAWINGS

FIGS. 1-11 show example embodiments of the methods and systems described herein.

FIG. 1 is a schematic diagram illustrating an example multi-party payment card industry system for enabling payment-by-card transactions in which merchants and card issuers do not necessarily have a one-to-one relationship.

FIG. 2 is a simplified block diagram of an example payment processing system including a payment processing server computing device, a profile generation computing device, and a plurality of computing devices in accordance with one example embodiment of the present disclosure.

FIG. 3 is an expanded block diagram of a server architecture of the payment processing system including the plurality of computing devices in accordance with one example embodiment of the present disclosure.

FIG. 4 illustrates a configuration of a client system shown in FIGS. 2 and 3 in accordance with one example embodiment of the present disclosure.

FIG. 5 illustrates a configuration of a server system shown in FIGS. 2 and 3 in accordance with one example embodiment of the present disclosure.

FIG. 6 is a diagram of signals transmitted between the profile generation computing device, the payment processing server computing device, supplemental data computing devices, and a client computing device, in accordance with an example embodiment of the present disclosure.

FIG. 7 is a map of a geographic area for which the profile generation computing device generates a profile.

FIG. 8 is diagram of data used by the profile generation computing device to generate a profile.

FIG. 9 is a relationship categories of goods purchased by a cardholder and reference categories of goods associated with respective socioeconomic statuses.

FIG. 10 is a flowchart of an example process implemented by the profile generation computing device for generating a profile of a geographic area in one example embodiment of the present disclosure.

FIG. 11 is a diagram of components of one or more example computing devices that may be used in the system shown in FIG. 2.

### DETAILED DESCRIPTION OF THE DISCLOSURE

The system described herein includes a profile generation computing device that includes a processor coupled to a memory. The profile generation computing device is in communication with a payment processing network (i.e., at least in communication with aggregated data generated by the payment network) and is configured to generate a profile of a predefined geographic area. More specifically, the profile generation computing device receives at least one transaction record signal. The transaction record signal includes records of a plurality of financial transactions processed by the payment processing network for a plurality of merchants within a predefined geographic area (e.g., a neighborhood). Additionally, the profile generation computing device identifies categories of goods purchased by a plurality of cardholders from the merchants in the predefined geographic area, based on the plurality of financial transactions. Further, the profile generation computing device determines that a subset of the cardholders are residents of the predefined geographic area based at least in part on determining that a subset of the cardholders purchased goods from the merchants in the predefined geographic area at a frequency that is at least equal to a reference frequency (e.g., seven times a week). Additionally, the profile generation computing device determines an estimated average socioeconomic status of the residents based on the categories of goods and generates a profile of the predefined geographic area, wherein the profile includes at least the estimated average socioeconomic status of the residents.

Additionally, the profile generation computing device, in at least some implementations, is communicatively coupled to a client computing device and is configured to receive a request signal from the client computing device including a request for profile information associated with the predefined geographic area. In response, the profile generation computing device transmits instructions to the client computing device to display at least a portion of the profile in association with a map of the predefined geographic area.

Further, in some implementations, the profile generation computing device determines the estimated average socioeconomic status of the residents by retrieving a plurality of reference socioeconomic status profiles from the memory. Each reference socioeconomic status profile includes reference categories of goods, and at least one of an income bracket and a list of interests. The profile generation computing device determines a respective similarity score between the identified categories of goods purchased by the residents and the reference categories of goods associated with each reference socioeconomic status profile. Additionally, the profile generation computing device associates the estimated average socioeconomic status with the reference socioeconomic status profile having the greatest similarity score.

In some implementations, the profile generation computing device determines at least one trend in spending associated with at least one of the plurality of merchants in the predefined geographic area. Additionally, the profile generation computing device determines that an amount of purchases made by the merchant using a payment account associated with the merchant has increased, decreased, or remained constant during a predefined time period. In some implementations, the profile generation computing device determines that a number of purchases from the merchant by the cardholders has increased, decreased, or remained constant during a predefined time period.

The profile generation computing device, in some implementations, identifies types of merchants within the predefined geographic area, based at least in part on the identified categories of goods, and includes the identified types of the merchants in the profile.

In some implementations, the profile generation computing device additionally retrieves supplemental data pertaining to the predefined geographic area, for example from a third party database. The supplemental data includes at least one of crime statistics, housing prices, new construction projects, school ratings, demographics, and weather information. The profile generation computing device includes at least a portion of the supplemental data in the profile.

The methods and systems described herein may be implemented using computer programming or engineering techniques including computer software, firmware, hardware or any combination or subset thereof, wherein the technical effect is achieved by performing at least one of: (a) receiving at least one transaction record signal including records of a plurality of financial transactions processed by the payment processing network for a plurality of merchants within a predefined geographic area; (b) identifying categories of goods purchased by a plurality of cardholders from the merchants in the predefined geographic area based on the plurality of financial transactions; (c) determining that a subset of the cardholders are residents of the predefined geographic area based at least in part on determining that a subset of the cardholders purchased goods from the merchants in the predefined geographic area at a frequency that is at least equal to a reference frequency; (d) determining an estimated average socioeconomic status of the residents based on the categories of goods; and (e) generating a profile of the predefined geographic area, wherein the profile includes at least the estimated average socioeconomic status of the residents. More specifically, a profile generation computing device described herein is specially programmed with computer code to perform the above processes. The technical effects described herein apply to the technical field of generating a profile of a geographic area, such as a neighborhood. The systems and methods described herein provide the technical advantage of analyzing payment transaction signals processed by a payment processing network and determining, based at least in part on the payment transaction signals, the types of people that live in a particular geographic area. Accordingly, potential residents and/or merchants may efficiently determine whether a particular geographic area is a good fit for their family or business.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, smartphones, personal digital assistants (PDAs), key fobs, and/or computers. Each type of transaction card can be used as a method of payment for performing a transaction.

In one embodiment, a computer program is provided, and the program is embodied on a computer-readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing financial transaction data by a third party in industrial, commercial, and residential applications.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

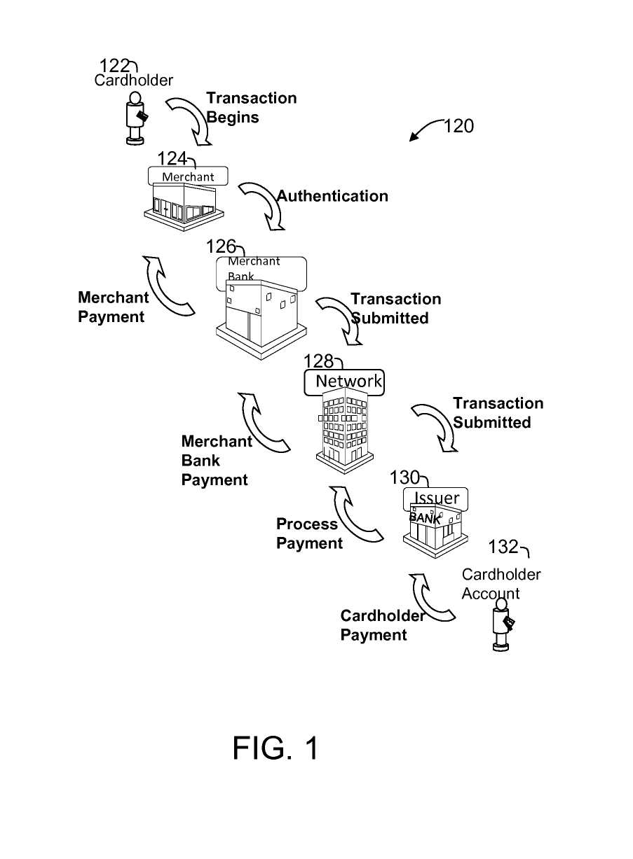

FIG. 1 is a schematic diagram illustrating an example multi-party payment card system 120 for enabling payment-by-card transactions in which merchants and card issuers do not necessarily have a one-to-one relationship. The present disclosure relates to payment card system 120, such as a credit card payment system using the MasterCard® payment card system payment network 128 (also referred to as an “interchange” or “interchange network”). MasterCard® payment card system payment network 128 is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.).

In payment card system 120, a financial institution such as an issuer 130 issues a payment account card, such as a credit card account or a debit card account, to a cardholder 122, who uses the payment account card to tender payment for a purchase from a merchant 124. To accept payment with the payment account card, merchant 124 must normally establish an account with a financial institution that is part of the financial payment system. This financial institution is usually called the “merchant bank” or the “acquiring bank” or “acquirer bank” or simply “acquirer”. When a cardholder 122 tenders payment for a purchase with a payment account card (also known as a financial transaction card), merchant 124 requests authorization from acquirer 126 for the amount of the purchase. The request may be performed over the telephone, but is usually performed through the use of a point-of-interaction terminal, which reads the cardholder's account information from the magnetic stripe on the payment account card or EMV chip and communicates electronically with the transaction processing computers of acquirer 126. Alternatively, acquirer 126 may authorize a third party to perform transaction processing on its behalf. In this case, the point-of-interaction terminal will be configured to communicate with the third party. Such a third party is usually called a “merchant processor” or an “acquiring processor.” In some instances, a merchant (e.g., merchant 124) stores payment card information associated with a cardholder (e.g., cardholder 122) and requests authorization from acquirer 126 using the stored payment card information, rather than reading the cardholder's account information from the payment card itself (i.e., a card-on-file (COF) transaction).

Using payment card system payment network 128, the computers of acquirer 126 or the merchant processor will communicate with the computers of issuer 130, to determine whether the cardholder's account 132 is in good standing and whether the purchase is covered by the cardholder's available credit line or account balance. Based on these determinations, the request for authorization will be declined or accepted. If the request is accepted, an authorization code is issued to merchant 124.

When a request for authorization is accepted, the available credit line or available balance of cardholder's account 132 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the goods or services, merchant 124 captures the transaction by, for example, appropriate data entry procedures on the point-of-interaction terminal. If a cardholder cancels a transaction before it is captured, a “void” is generated. If a cardholder returns goods after the transaction has been captured, a “credit” is generated.

For PIN debit card transactions, when a request for authorization is approved by the issuer, the cardholder's account 132 is decreased. Normally, a charge is posted immediately to cardholder's account 132. The bankcard association then transmits the approval to the acquiring processor for distribution of goods/services, or information or cash in the case of an ATM.

After a transaction is captured, the transaction is cleared and settled between merchant 124, acquirer 126, and issuer 130. Clearing refers to the communication of financial data for reconciliation purposes between the parties. Settlement refers to the transfer of funds between the merchant's account, acquirer 126, and issuer 130 related to the transaction.

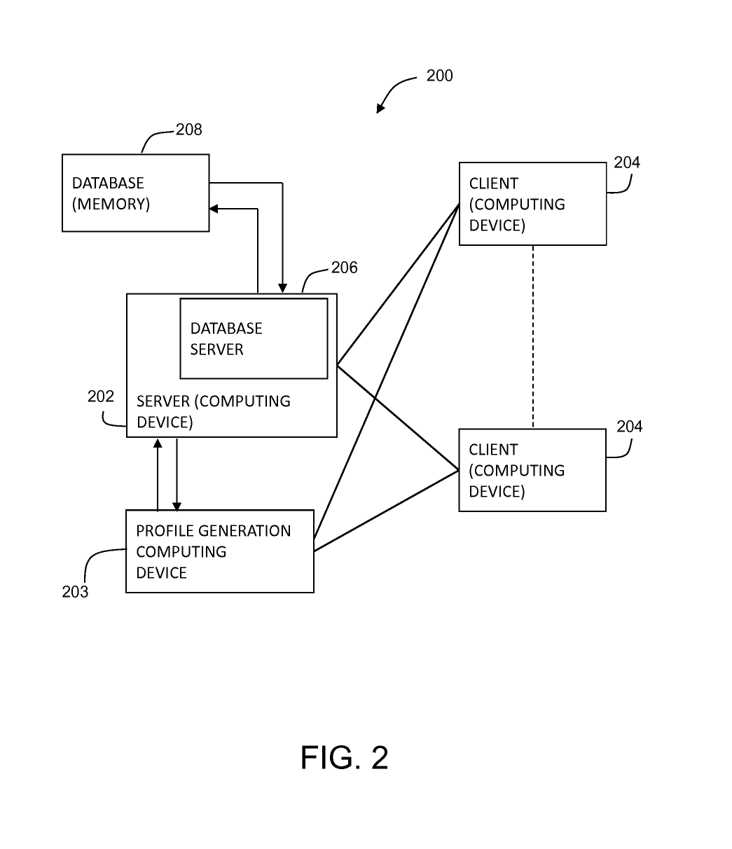

FIG. 2 is a simplified block diagram of an example payment processing system 200 with a profile generation computing device 203 in accordance with one embodiment of the present disclosure. In the example embodiment, system 200 includes a payment processing server computing device 202, profile generation computing device 203 and a plurality of client subsystems, also referred to as client systems 204 or client computing devices, connected to payment processing server computing device 202 and profile generation computing device 203. In one embodiment, client systems 204 are computers including a web browser, such that profile generation computing device 203 is accessible to client systems 204 using the Internet. Client systems 204 are interconnected to the Internet through many interfaces including a network, such as a local area network (LAN) and/or a wide area network (WAN), dial-in connections, cable modems, wireless-connections, and special high-speed ISDN lines. Client systems 204 may be any device capable of interconnecting to the Internet including a web-based phone, personal digital assistant (PDA), or other web-connectable equipment. In one embodiment, client computing device 204 includes a point-of-sale (POS) device, a cardholder computing device (e.g., a smartphone, a tablet, or other computing device), or any other computing device capable of communicating with payment processing server computing device 202 and/or profile generation computing device 203. A database server 206 is connected to a database 208 containing information on a variety of matters, as described below in greater detail. In one embodiment, database 208 is stored on profile generation computing device 203 and may be accessed by potential users at one of client systems 204 by logging onto profile generation computing device 203 through one of client systems 204. In any alternative embodiment, database 208 is stored remotely from profile generation computing device 203 and may be non-centralized. Profile generation computing device 203 could be any type of computing device configured to perform the steps described herein. As discussed below, payment transaction records, merchant locations, geographic areas, categories of goods, and profiles are stored in database 208.

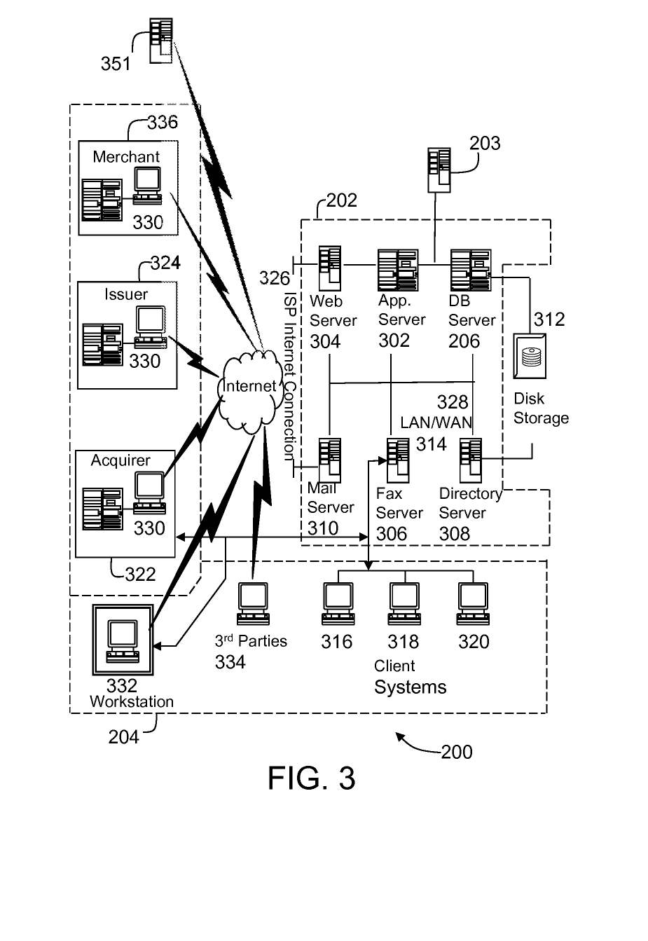

FIG. 3 is an expanded block diagram of an example embodiment of a server architecture of payment processing system 200 in accordance with one embodiment of the present disclosure. Payment processing system 200 includes payment processing server computing device 202, profile generation computing device 203, and client systems 204. At least one supplemental data computing device 351 is communicatively coupled to payment processing system, for example through the Internet. Payment processing server computing device 202 includes database server 206, an application server 302, a web server 304, a fax server 306, a directory server 308, and a mail server 310. A disk storage unit 312 is coupled to database server 206 and directory server 308. Servers 206, 302, 304, 306, 308, and 310 are coupled in a local area network (LAN) 314. In addition, a system administrator's workstation 316, a user workstation 318, and a supervisor's workstation 320 are coupled to LAN 314. Alternatively, workstations 316, 318, and 320 are coupled to LAN 314 using an Internet link or are connected through an Intranet.

Each workstation, 316, 318, and 320, is a personal computer having a web browser. Although the functions performed at the workstations typically are illustrated as being performed at respective workstations 316, 318, and 320, such functions can be performed at one of many personal computers coupled to LAN 314. Workstations 316, 318, and 320 are illustrated as being associated with separate functions only to facilitate an understanding of the different types of functions that can be performed by individuals having access to LAN 314.

Profile generation computing device 203 is configured to be communicatively coupled to various entities, including acquirers 322 and issuers 324, and to third parties 334 (e.g., potential residents or businesses interested in moving into a particular geographic area) using an Internet connection 326. Server system 202 is also communicatively coupled with one or more merchants 336, for example merchants that are already located in the geographic area. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 328, local area network 314 could be used in place of WAN 328.

In the example embodiment, any authorized individual or entity having a workstation 330 may access system 200. At least one of the client systems includes a manager workstation 332 located at a remote location. Workstations 330 and 332 include personal computers having a web browser. Also, workstations 330 and 332 are configured to communicate with profile generation computing device 203. Furthermore, fax server 306 communicates with remotely located client systems, including a client system 332, using a telephone link. Fax server 306 is configured to communicate with other client systems 316, 318, and 320 as well.

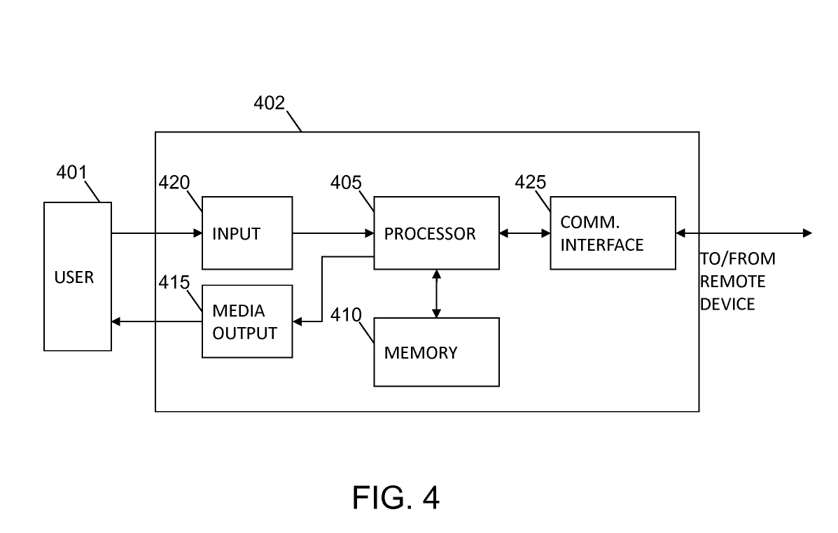

FIG. 4 illustrates an example configuration of a client computing device 402. Client computing device 402 may include, but is not limited to, client systems (“client computing devices”) 204, 316, 318, and 320, workstations 330 and 332, computing devices of third parties 334, and supplemental data computing devices 351.

Client computing device 402 includes a processor 405 for executing instructions. In some embodiments, executable instructions are stored in a memory area 410. Processor 405 may include one or more processing units (e.g., in a multi-core configuration). Memory area 410 is any device allowing information such as executable instructions and/or other data to be stored and retrieved. Memory area 410 may include one or more computer-readable media.

Client computing device 402 also includes at least one media output component 415 for presenting information to a user 401 (e.g., a cardholder 122). Media output component 415 is any component capable of conveying information to user 401. In some embodiments, media output component 415 includes an output adapter such as a video adapter and/or an audio adapter. An output adapter is operatively coupled to processor 405 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 402 includes an input device 420 for receiving input from user 401. Input device 420 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 415 and input device 420.

Client computing device 402 may also include a communication interface 425, which is communicatively couplable to a remote device such as server system 202 or a web server operated by a merchant. Communication interface 425 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 410 are, for example, computer-readable instructions for providing a user interface to user 401 via media output component 415 and, optionally, receiving and processing input from input device 420. A user interface may include, among other possibilities, a web browser and client application. Web browsers enable users 401 to display and interact with media and other information typically embedded on a web page or a website from a web server associated with a merchant. A client application allows users 401 to interact with a server application associated with a merchant.

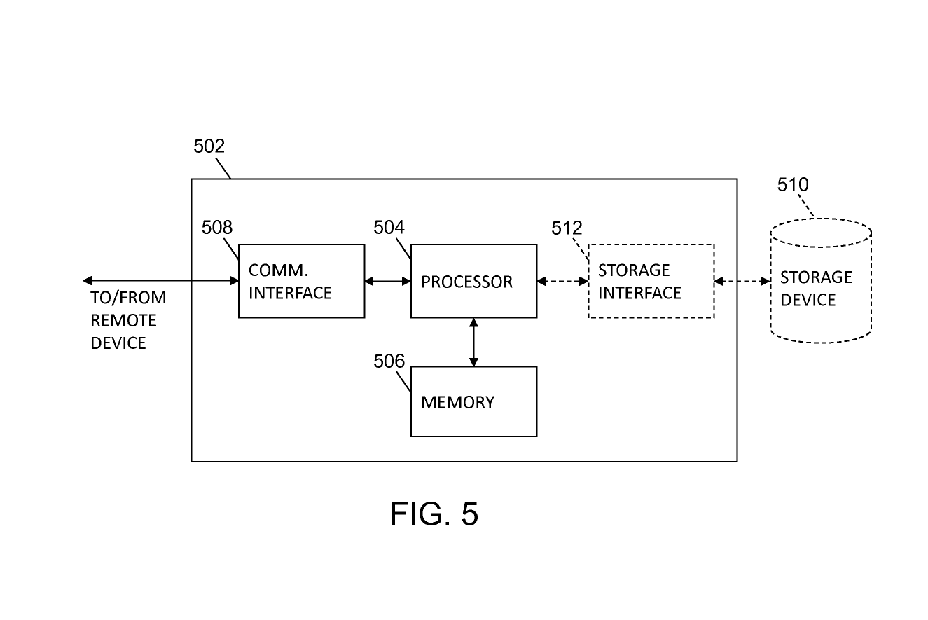

FIG. 5 illustrates an example configuration of a server computing device 502 such as payment processing server computing device 202 (shown in FIGS. 2 and 3). Server computing device 502 is representative of database server 206, application server 302, web server 304, fax server 306, directory server 308, mail server 310, and profile generation computing device 203.

Server computing device 502 includes a processor 504 for executing instructions. Instructions may be stored in a memory area 506, for example. Processor 504 may include one or more processing units (e.g., in a multi-core configuration).

Processor 504 is operatively coupled to a communication interface 508 such that server computing device 502 is capable of communicating with a remote device such as client computing device 402 or another server computing device 502. For example, communication interface 508 may receive requests from client systems 204 via the Internet, as illustrated in FIGS. 2 and 3.

Processor 504 may also be operatively coupled to a storage device 510. Storage device 510 is any computer-operated hardware suitable for storing and/or retrieving data. In some embodiments, storage device 510 is integrated in server computing device 502. For example, server computing device 502 may include one or more hard disk drives as storage device 510. In other embodiments, storage device 510 is external to server computing device 502 and may be accessed by a plurality of server computing devices 502. For example, storage device 510 may include multiple storage units such as hard disks or solid state disks in a redundant array of inexpensive disks (RAID) configuration. Storage device 510 may include a storage area network (SAN) and/or a network attached storage (NAS) system.

In some embodiments, processor 504 is operatively coupled to storage device 510 via a storage interface 512. Storage interface 512 is any component capable of providing processor 504 with access to storage device 510. Storage interface 512 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 504 with access to storage device 510.

Memory areas 410 and 506 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of data and/or a computer program.

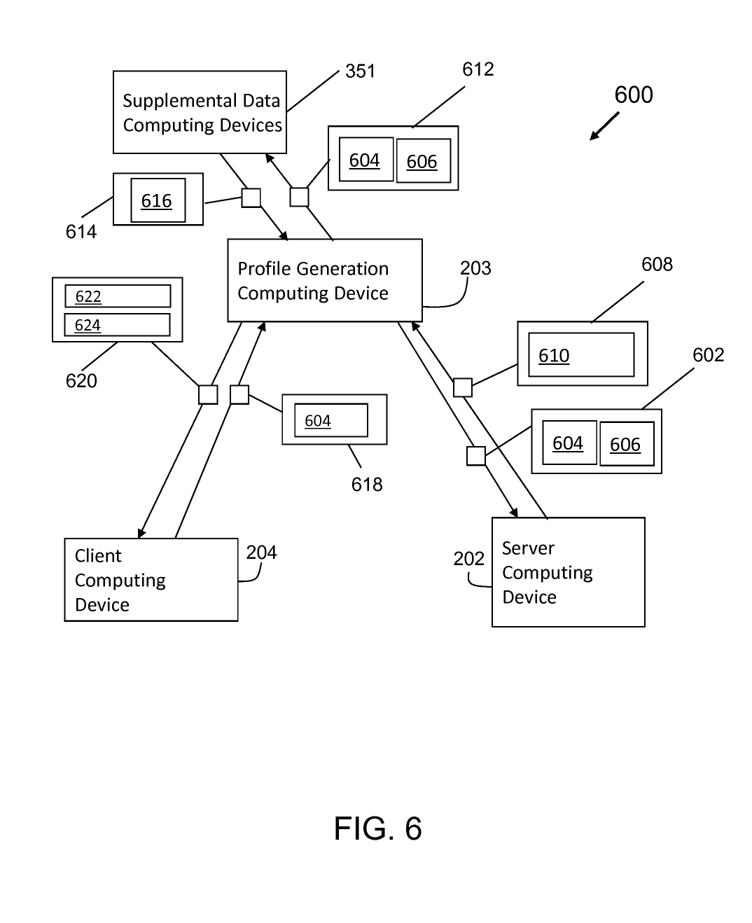

FIG. 6 is a diagram 600 of signals transmitted between profile generation computing device 203, payment processing server computing device 202, supplemental data computing devices 351, and a client computing device 204. Profile generation computing device 203 transmits a record request signal 602 to payment processing server computing device 202 for payment transaction records. In some implementations, record request signal 602 includes an area identifier 604 of a geographic area, for example a zip code, a listing of streets that bound the geographic area, and/or a name of the geographic area (e.g., a name of a neighborhood). In some implementations, record request signal 602 includes a time period identifier 606, for example a start date and an end date. Payment processing server computing device 202 retrieves payment transaction records from database 208, in response to record request signal 602. For example, payment processing server computing device 202 retrieves payment transaction records for purchases made at merchant locations within the geographic area indicated by area identifier 604, during the time period identified by time period identifier 606. Payment processing server computing device 202 transmits a record response signal 608 to profile generation computing device 203. Record response signal 608 includes the payment transaction records 610 retrieved by payment processing server computing device 202 in response to record request signal.

Additionally, profile generation computing device 203 transmits a supplemental data request signal 612 to supplemental data computing devices 351. In some implementations, supplemental data request signal includes one or more of area identifier 604 and time period identifier 606. In response, supplemental data computing devices 351 transmit a supplemental data response signal 614 that includes supplemental data 616, for example supplemental data pertaining to the geographic area identified by area identifier 604 for the time period identified by time period identifier 606. Supplemental data 616 includes data pertaining to crime statistics, housing prices, construction projects, school ratings, demographics, and weather for a geographic area (e.g., the geographic area identified by area identifier 604). Supplemental data computing devices 351 in at least some implementations, are a plurality of different computing devices, each associated with a different source of supplemental data 616 (e.g., a government-related computing device with demographic information, a real estate computing device with data pertaining to housing prices and new construction projects, a meteorological computing device associated with a weather station, etc.)

A client computing device 204 transmits a profile request signal 618 to profile generation computing device 203. Profile request signal 618 includes area identifier 604. In response, profile generation computing device 203 transmits a profile response signal 620 to client computing device 204. Profile response signal 620 includes a profile 622 associated with the geographic area identified by area identifier 604 and, in at least some implementations, computer-executable instructions 624 for displaying data from profile 622 in association with a graphical depiction (e.g., a map) of the geographic area.

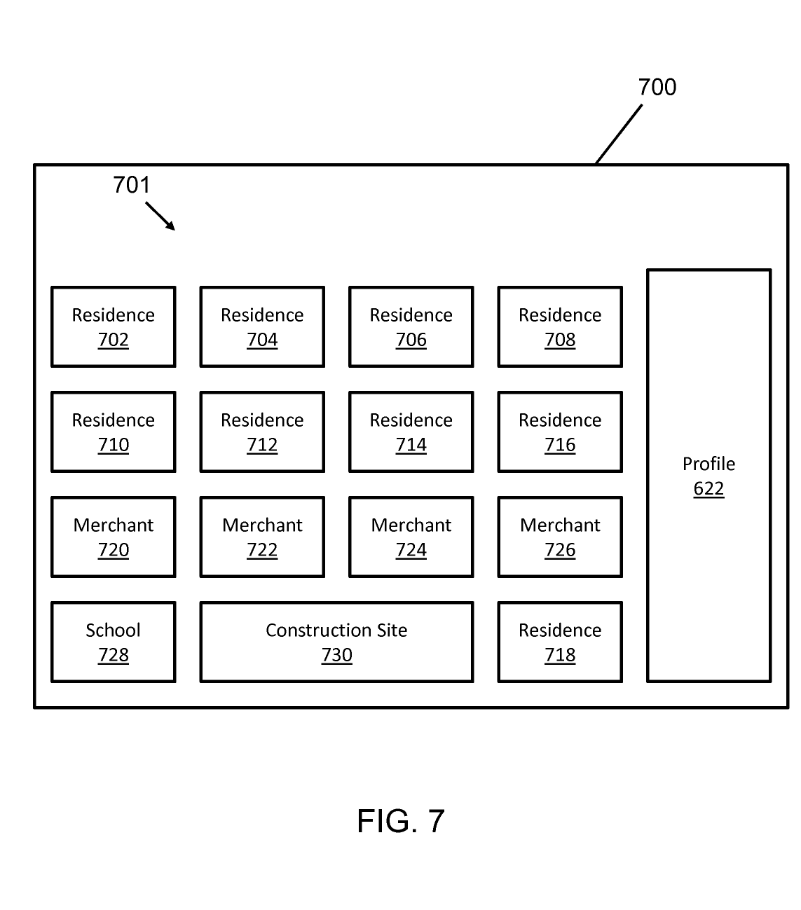

FIG. 7 is a map 700 of a geographic area 701 for which profile generation computing device 203 generates profile 622. Geographic area 701 is, for example, a neighborhood. At least some cardholders 122 that purchase goods using payment processing network 128 live in geographic area 701. Geographic area 701 includes a first residence 702, a second residence 704, a third residence 706, a fourth residence 708, a fifth residence 710, a sixth residence 712, a seventh residence 714, an eighth residence 716, and a ninth residence 718. Additionally, geographic area 701 includes a first merchant 720, a second merchant 722, a third merchant 724, and a fourth merchant 726. Geographic area 701 also includes a school 728 and a new construction site 730.

As described in more detail herein, profile generation computing device 203 generates profile 622 based on purchases made by cardholders 122 living in geographic area 701 and, at least in some implementations, supplemental data 616 that pertains to geographic area 701. In at least some implementations, profile generation computing device 203 transmits instructions 624 to client computing device 204 to display map 700 in association with profile 622. For example, in some implementations, profile 622 is displayed as text and/or graphics adjacent to geographic area 701 in map 700. In some implementations, all or a portion of profile 622 is represented as one or more colors, symbols, or other indicia overlaid on one or more portions of geographic area 701 in map 700.

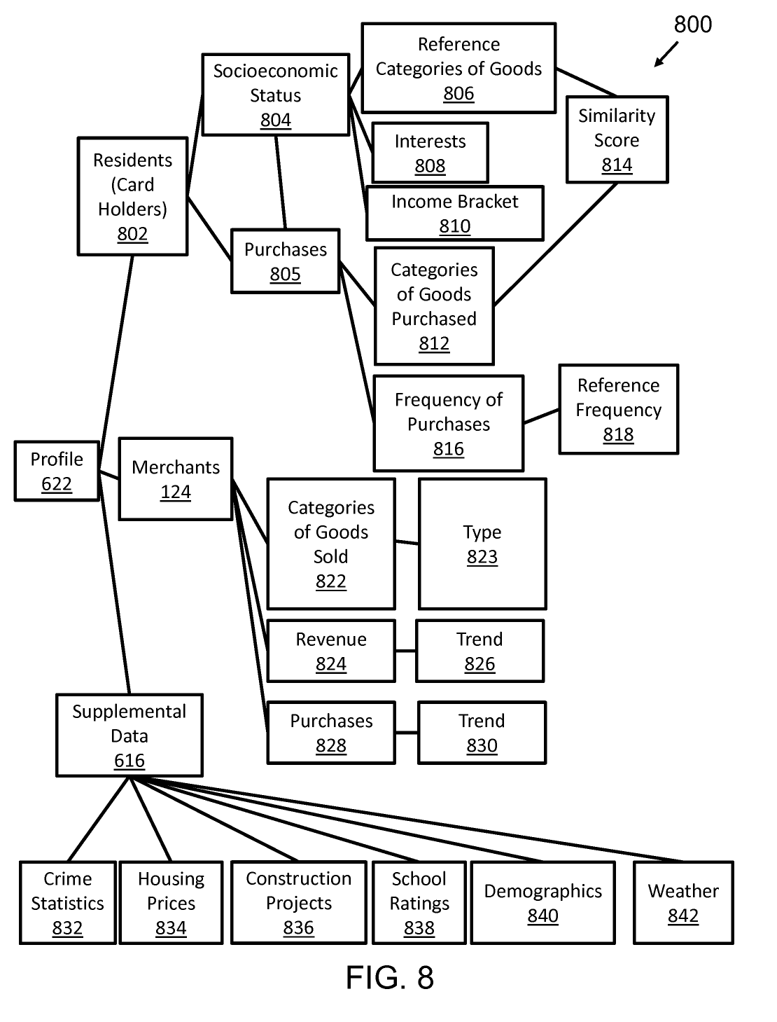

FIG. 8 is diagram 800 of data used by profile generation computing device 203 to generate profile 622. Profile generation computing device 203 uses data pertaining to residents 802 of geographic area 701. More specifically, profile generation computing device 203 determines a socioeconomic status 804, such as an average socioeconomic status, of cardholders that are residents of geographic area 701. Profile generation computing device 203 determines the socioeconomic status 804 based on purchases 805 made by residents 802, based on payment transaction records 610 (FIG. 6). Profile generation computing device 203 determines that particular cardholders 122 are residents 802 by comparing a frequency 816 of purchases made using payment card accounts associated with cardholders 122 from merchants (e.g., first merchant 720, second merchant 722, third merchant 724, and fourth merchant 726) located in geographic area 701 to a reference frequency 818. For example, if certain cardholders 122 purchase from one or more of first merchant 720, second merchant 722, third merchant 724, and fourth merchant 726 at least three times a week (i.e., reference frequency 818), then profile generation computing device 203 determines that those cardholders 122 are residents 802 of geographic area 701. Importantly, in at least some implementations, profile generation computing device 203 does not store residence information and characteristics of cardholders on a cardholder-by-cardholder basis, but rather stores such characteristics (e.g., socioeconomic status 804) in an aggregate form, for example as characteristics pertaining a group of resident cardholders.

Profile generation computing device 203 associates one or more reference categories of goods 806 with socioeconomic status 804. Additionally, profile generation computing device 203 associates one or more interests 808 and an income bracket 810 with socioeconomic status 804. As described in more detail herein, profile generation computing device 203 compares categories of goods purchased 812 by residents 802 through payment network 128 to a reference category of goods 806 associated with each of a plurality of predefined socioeconomic statuses (e.g., socioeconomic status 804) and determines a similarity score 814 for each comparison. Profile generation computing device 203 then ranks the similarity score 814 associated with each comparison and selects the socioeconomic status (e.g., socioeconomic status 804) associated with the highest similarity score (i.e., similarity in goods actually purchased by the residents 802 to the reference categories of goods 806) as the socioeconomic status 804 of residents 802. Profile generation computing device 203 and/or payment processing server computing device 202 stores categories of goods sold by merchants 124 in a database (e.g., database 208), for example when a merchant registers with payment network 128. More specifically, in at least some implementations, each merchant 124 submits, to payment network 128, a description or categories of goods sold by the merchant 124 when merchant 124 registers with payment network 128. Accordingly, profile generation computing device 203 references the stored categories of goods 822 associated with each merchant 124 when analyzing payment transaction record 610 that identifies the merchant 124. Profile generation computing device 203 then attributes the categories of goods 822 associated with the merchant 124 to the categories of goods 812 purchased by residents 802. In some implementations, profile generation computing device 203 associates a merchant (e.g., first merchant 720) with a type 823, based on the categories of goods sold 822 by the merchant. For example, if categories of goods sold 822 by first merchant 720 includes helmets, bikes, and shoes, then profile generation computing device 203 determines that first merchant is a sporting goods store. In some implementations, profile generation computing device 203 stores a lookup table that associates categories of goods sold 822 with corresponding merchant types 823.

Additionally, profile generation computing device 203 analyzes estimated revenues of merchants 124. For example, profile generation computing device 203 sums payment transaction records 610 associated with each merchant 124 in geographic area 701 (e.g., first merchant 720) during a predefined time period, such as the time period identified by time period identifier 606. In at least some implementations, profile generation computing device 203 multiplies the sum by a predefined number to account for sales that the merchant 124 likely made that were not processed through payment network 128 (e.g., cash transactions). Additionally, profile generation computing device 203 determines a trend 826 in revenue, for example by comparing revenue in a first month to revenue in a subsequent month, to determine whether the revenue is increasing, decreasing, or staying constant. Further, profile generation computing device 203 identifies payment transaction records 610 indicating purchases 828 made by a merchant 124 located in geographic area 701 (e.g., first merchant 720) and determines a trend 830 in the purchases. For example, profile generation computing device 203 determines whether the total value of purchases 828 are increasing, decreasing, or staying the same each month. Trends 826 and 830 are indicators of whether the merchant 124 (e.g., first merchant 720) is thriving in geographic area 701 or having financial difficulty. In at least some implementations, profile generation computing device 203 associates trends 826 and 830 with the categories of goods sold 822 by each merchant 124 located in geographic area 701. More specifically, if one or more of trends 826 and 830 is decreasing, then profile generation computing device 203 determines that geographic area 701 is not conducive to selling the categories of goods sold 822 by the respective merchant.

In addition to analyzing data pertaining to residents 802 and merchants 124 of geographic area 701, profile generation computing device additionally receives supplemental data 616 about geographic area 701 from one or more supplemental data computing devices 351, as described with reference to FIG. 6. Supplemental data 616 includes crime statistics 832, housing prices 834, construction projects 836, for example data indicating the construction is being performed at construction site 730, school ratings 838, for example a rating of school 728, demographics 840 (e.g., age, marital status, gender, and/or ethnicity) for example from a census, and weather data 842. Profile generation computing device 203 combines data pertaining to residents (e.g., socioeconomic status 804), merchants 124 located in geographic area 701 (e.g., categories of goods sold 822 and trends 826 and 830), and supplemental data 616 into profile 622. In response to receiving a profile request signal 618, for example from client computing device 204, profile generation computing device 203 transmits profile response signal 620 to client computing device 204 to display at least a portion of profile 622 in association with a map 700 of geographic area 701, thereby enabling a user of client computing device 204 to quickly form an impression of geographic area 701 without having to physically visit geographic area 701 and/or research data about geographic area 701 from multiple different sources.

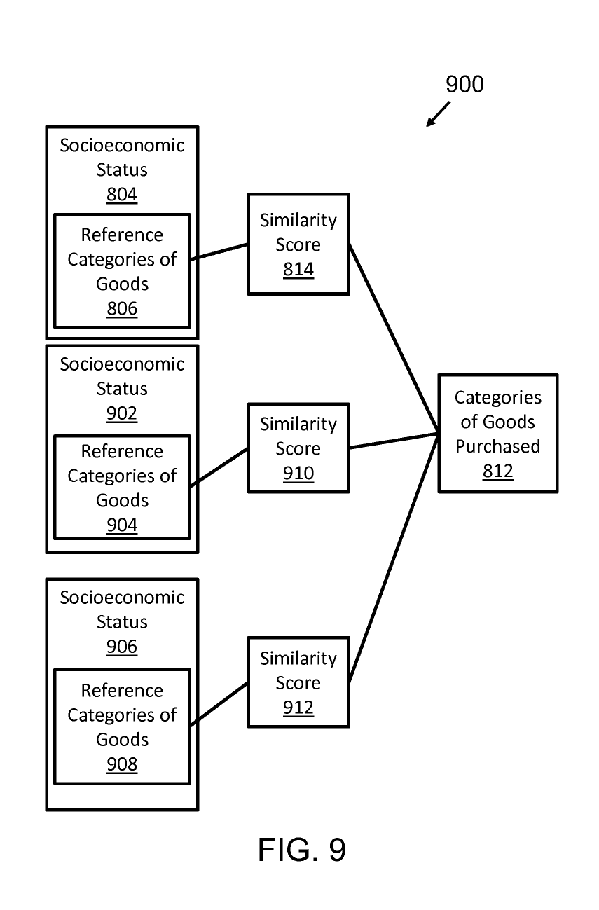

FIG. 9 is a diagram of a relationship 900 of categories of goods purchased by a cardholder 122 and reference categories of goods associated with respective socioeconomic statuses. More specifically, profile generation computing device 203 stores, in memory (e.g., database 208), a plurality of socioeconomic statuses, including first socioeconomic status 804, second socioeconomic status 902, and third socioeconomic status 906. Additionally, profile generation computing device 203 stores at least one reference category of goods associated with each socioeconomic status. More specifically, profile generation computing device 203 stores first reference categories of goods 806 in association with first socioeconomic status 804, second reference categories of goods 904 in association with second socioeconomic status 902, and third reference categories of goods 908 in association with third socioeconomic status 906. Profile generation computing device 203 then compares categories of goods purchased by a cardholder 122 with the reference categories of goods 806, 904, and 908 and determines a corresponding similarity score (e.g., first similarity score 814, second similarity score 910, and third similarity score 912). Each similarity score 814, 910, 912 is for example a numeric value that represents how many of the categories of goods purchased 812 are the same as the reference categories of goods associated with each socioeconomic class. Profile generation computing device 203 then assigns the socioeconomic status associated with the largest similarity score (e.g., socioeconomic status 804 and similarity score 814) as the average socioeconomic status of residents 802.

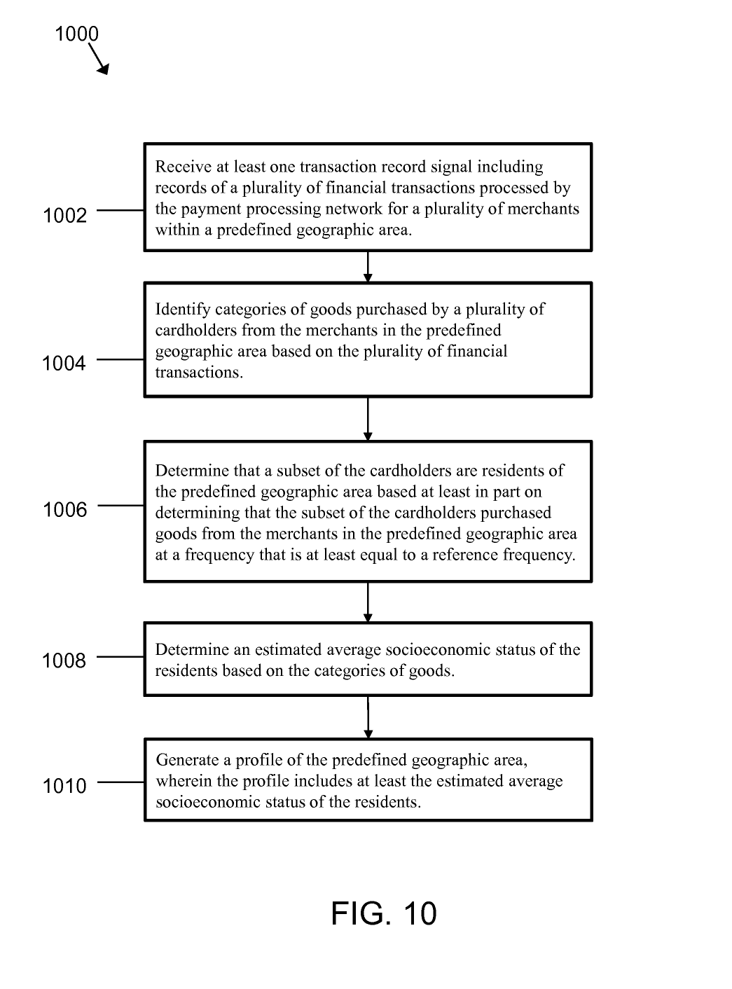

FIG. 10 is a flowchart of an example process 1000 implemented by profile generation computing device 203 for generating a profile (e.g., profile 622) of a geographic area (e.g., geographic area 701). Initially, profile generation computing device 203 receives 1002 at least one transaction record signal (e.g., record response signal 608) including records (e.g., payment transaction records 610) of a plurality of financial transactions processed by the payment processing network 128 for a plurality of merchants 124 (e.g., first merchant 720, second merchant 722, third merchant 724, and fourth merchant 726) within a predefined geographic area (e.g., geographic area 701). Additionally, profile generation computing device 203 identifies 1004 categories of goods purchased (e.g., categories of goods purchased 812) by a plurality of cardholders 122 from the merchants 124 (e.g., first merchant 720, second merchant 722, third merchant 724, and fourth merchant 726) in the predefined geographic area 701 based on the plurality of financial transactions (e.g., payment transaction records 610).

Additionally, profile generation computing device 203 determines 1006 that a subset (e.g., residents 802) of the cardholders 122 are residents of the predefined geographic area 701 based at least in part on determining that the subset (e.g., residents 802) of the cardholders 122 purchased goods from the merchants 124 (e.g., first merchant 720, second merchant 722, third merchant 724, and fourth merchant 726) in the predefined geographic area 701 at a frequency (e.g., frequency of purchases 816) that is at least equal to a reference frequency (e.g., reference frequency 818). Further, profile generation computing device 203 determines 1008 an estimated average socioeconomic status (e.g., socioeconomic status 804) of the residents 802 based on the categories of goods 812. Additionally, profile generation computing device 203 generates 1010 a profile (e.g., profile 622) of the predefined geographic area 701, wherein the profile 622 includes at least the estimated average socioeconomic status (e.g., socioeconomic status 804) of the residents 802.

In some implementations, profile generation computing device 203 is communicatively coupled to a client computing device (e.g., client computing device 204) and is configured to receive a request signal (e.g., profile request signal 618) from the client computing device 204 including a request for profile information (e.g., area identifier 604) associated with the predefined geographic area 701. Additionally, profile generation computing device 203 transmits instructions (e.g., instructions 624) to the client computing device 204 to display at least a portion of the profile 622 in association with a map 700 of the predefined geographic area 701.

In some implementations, profile generation computing device 203 determines the estimated average socioeconomic status (e.g., socioeconomic status 804) of the residents 802 by retrieving a plurality of reference socioeconomic status profiles (e.g., socioeconomic status 804, socioeconomic status 902, and socioeconomic status 906) from the memory 208, wherein each reference socioeconomic status profile includes reference categories of goods (e.g., reference categories of goods 806, reference categories of goods 904, and reference categories of goods 908), and at least one of an income bracket (e.g., income bracket 810) and a list of interests (e.g., interests 808). Additionally, profile generation computing device 203 determines a respective similarity score (e.g., similarity score 814, similarity score 910, and similarity score 912) between the identified categories of goods purchased (categories of goods purchased 812) by the residents 802 and the reference categories of goods (e.g., reference categories of goods 806, reference categories of goods 904, and reference categories of goods 908) associated with each reference socioeconomic status profile. Additionally, profile generation computing device 203 associates the estimated average socioeconomic status with the reference socioeconomic status profile having the greatest similarity score (e.g., similarity score 814).

In some implementations, profile generation computing device 203 determines at least one trend (e.g., trend 830) in spending associated with at least one of the plurality of merchants (e.g., first merchant 720) in the predefined geographic area 701. Further, in some implementations, profile generation computing device 203 determines that an amount of purchases made using a payment account associated with the merchant (e.g., first merchant 720) has increased, decreased, or remained constant during a predefined time period (e.g., two months). In some implementations, profile generation computing device 203 determines that an amount of purchases (e.g., revenue 824) made from the merchant (e.g., first merchant 720) by the cardholders 122 has increased, decreased, or remained constant (e.g., trend 826) during a predefined time period (e.g., two months).

In some implementations, profile generation computing device 203 identifies types (e.g., type 823) of merchants (e.g., first merchant 720) within the predefined geographic area 701 based at least in part on the identified categories of goods (e.g., categories of goods sold 822) and includes the identified types (e.g., type 823) of the merchants in the profile 622. In some implementations, profile generation computing device 203 retrieves supplemental data (e.g., supplemental data 616) pertaining to the predefined geographic area 701, wherein the supplemental data 616 includes at least one of crime statistics 832, housing prices 834, new construction projects 836, school ratings 838, demographics 840, and weather 842 associated with the predefined geographic area 701 and includes at least a portion of the supplemental data 616 in the profile 622.

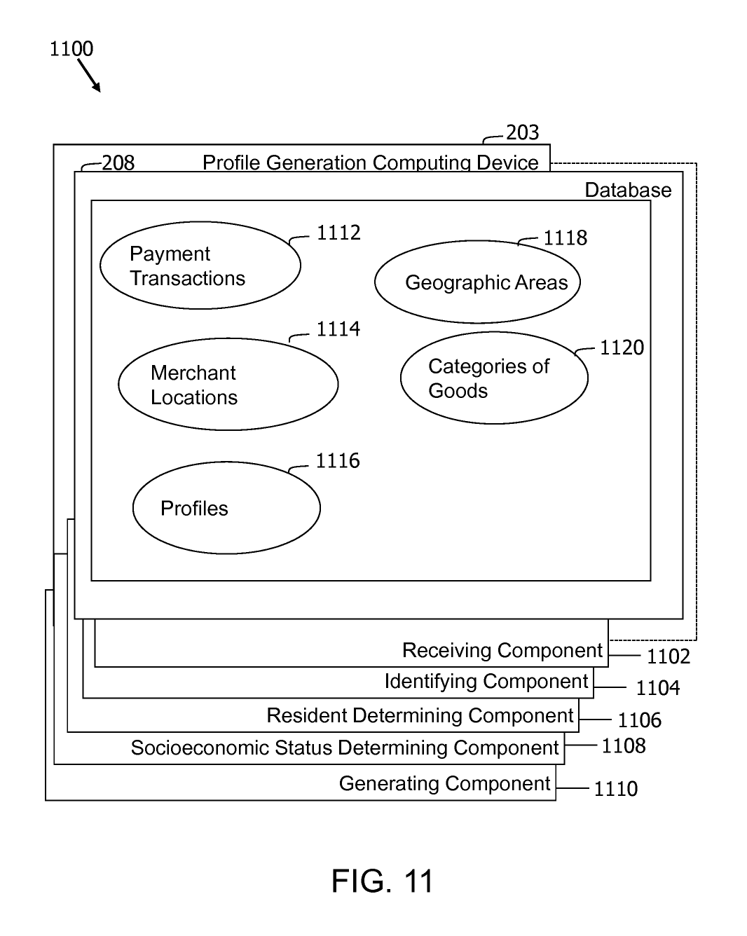

FIG. 11 is a diagram 1100 of components of one or more example computing devices, for example, profile generation computing device 203, that may be used in embodiments of the described systems and methods. FIG. 11 further shows a configuration of database 208 (FIG. 2). Database 208 is in communication with several separate components within profile generation computing device 203, which perform specific tasks.

Profile generation computing device 203 includes a receiving component 1102 for receiving at least one transaction record signal including records of a plurality of financial transactions processed by the payment processing network for a plurality of merchants within a predefined geographic area. Additionally, profile generation computing device 203 includes an identifying component for identifying categories of goods purchased by a plurality of cardholders from the merchants in the predefined geographic area based on the plurality of financial transactions. Additionally, profile generation computing device 203 includes a resident determining component 1106 for determining that a subset of the cardholders are residents of the predefined geographic area based at least in part on determining that the subset of the cardholders purchased goods from the merchants in the predefined geographic area at a frequency that is at least equal to a reference frequency. Additionally, profile generation computing device 203 includes a socioeconomic status determining component 1108 for determining an estimated average socioeconomic status of the residents based on the categories of goods. Further, profile generation computing device 203 includes a generating component 1110 for generating a profile of the predefined geographic area, wherein the profile includes at least the estimated average socioeconomic status of the residents.

In an example embodiment, database 208 is divided into a plurality of sections, including but not limited to, a payment transactions section 1112, a merchant locations section 1114, a profiles section 1116, a geographic areas section 1118, and a categories of goods section 1120. These sections within database 208 are interconnected to retrieve and store information in accordance with the functions and processes described above.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 405, 504, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

The above-described embodiments of a method and system for generating a profile of a geographic area utilize records of financial transactions processed by a payment network to provide a third party, such as a person interested in living in or establishing a business in the geographic area, with information regarding the people living in the geographic area, and associated information that would be difficult to obtain without physically visiting the area and researching information from multiple different sources.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A profile generation computing device for generating a profile of a predefined geographic area, said profile generation computing device comprising a processor coupled to a memory, said profile generation computing device is in communication with a payment processing network and is configured to:
receive at least one transaction record signal including records of a plurality of financial transactions processed by the payment processing network for a plurality of merchants within a predefined geographic area;
identify categories of goods purchased by a plurality of cardholders from the merchants in the predefined geographic area based on the plurality of financial transactions;
determine that a subset of the cardholders are residents of the predefined geographic area based at least in part on determining that a subset of the cardholders purchased goods from the merchants in the predefined geographic area at a frequency that is at least equal to a reference frequency;
determine an estimated average socioeconomic status of the residents based on the categories of goods; and
generate a profile of the predefined geographic area, wherein the profile includes at least the estimated average socioeconomic status of the residents.

2. The profile generation computing device of claim 1, wherein said profile generation computing device is communicatively coupled to a client computing device, said profile generation computing device is further configured to:
receive a request signal from the client computing device including a request for profile information associated with the predefined geographic area; and
transmit instructions to the client computing device to display at least a portion of the profile in association with a map of the predefined geographic area.

3. The profile generation computing device of claim 1, further configured to determine the estimated average socioeconomic status of the residents by:
retrieving a plurality of reference socioeconomic status profiles from the memory, wherein each reference socioeconomic status profile includes reference categories of goods, and at least one of an income bracket and a list of interests;
determining a respective similarity score between the identified categories of goods purchased by the residents and the reference categories of goods associated with each reference socioeconomic status profile; and
associating the estimated average socioeconomic status with the reference socioeconomic status profile having the greatest similarity score.

4. The profile generation computing device of claim 1, further configured to determine at least one trend in spending associated with at least one of the plurality of merchants in the predefined geographic area.

5. The profile generation computing device of claim 4, further configured to determine that an amount of purchases made using a payment account associated with the merchant has increased, decreased, or remained constant during a predefined time period.

6. The profile generation computing device of claim 4, further configured to determine that an amount of purchases made from the merchant by the cardholders has increased, decreased, or remained constant during a predefined time period.

7. The profile generation computing device of claim 1, further configured to:
identify types of merchants within the predefined geographic area based at least in part on the identified categories of goods; and
include the identified types of the merchants in the profile.

8. The profile generation computing device of claim 1, further configured to:
retrieve supplemental data pertaining to the predefined geographic area, wherein the supplemental data includes at least one of crime statistics, housing prices, new construction projects, school ratings, demographics, and weather associated with the predefined geographic area; and
include at least a portion of the supplemental data in the profile.

9. A method for generating a profile of a predefined geographic area, the method is implemented by a profile generation computing device in communication with a payment processing network, the profile generation computing device includes one or more processors in communication with a memory, said method comprising:
receiving, by the profile generation computing device, at least one transaction record signal including records of a plurality of financial transactions processed by the payment processing network for a plurality of merchants within a predefined geographic area;
identifying, by the profile generation computing device, categories of goods purchased by a plurality of cardholders from the merchants in the predefined geographic area based on the plurality of financial transactions;
determining, by the profile generation computing device, that a subset of the cardholders are residents of the predefined geographic area based at least in part on determining that a subset of the cardholders purchased goods from the merchants in the predefined geographic area at a frequency that is at least equal to a reference frequency;
determining, by the profile generation computing device, an estimated average socioeconomic status of the residents based on the categories of goods; and
generating, by the profile generation computing device, a profile of the predefined geographic area, wherein the profile includes at least the estimated average socioeconomic status of the residents.

10. The method of claim 9, wherein the profile generation computing device is communicatively coupled to a client computing device, the method further comprising:
receiving a request signal from the client computing device including a request for profile information associated with the predefined geographic area; and
transmitting instructions to the client computing device to display at least a portion of the profile in association with a map of the predefined geographic area.

11. The method of claim 9, wherein determining the estimated average socioeconomic status of the residents further comprises:
retrieving a plurality of reference socioeconomic status profiles from the memory, wherein each reference socioeconomic status profile includes reference categories of goods, and at least one of an income bracket and a list of interests;
determining a respective similarity score between the identified categories of goods purchased by the residents and the reference categories of goods associated with each reference socioeconomic status profile; and
associating the estimated average socioeconomic status with the reference socioeconomic status profile having the greatest similarity score.

12. The method of claim 9, further comprising determining at least one trend in spending associated with at least one of the plurality of merchants in the predefined geographic area.

13. The method of claim 12, further comprising determining that an amount of purchases made using a payment account associated with the merchant has increased, decreased, or remained constant during a predefined time period.

14. The method of claim 12, further comprising determining that an amount of purchases made from the merchant by the cardholders has increased, decreased, or remained constant during a predefined time period.

15. The method of claim 9, further comprising:
identifying types of merchants within the predefined geographic area based at least in part on the identified categories of goods; and
including the identified types of the merchants in the profile.

16. The method of claim 9, further comprising:
retrieving supplemental data pertaining to the predefined geographic area, wherein the supplemental data includes at least one of crime statistics, housing prices, new construction projects, school ratings, demographics, and weather associated with the predefined geographic area; and
including at least a portion of the supplemental data in the profile.

17. A computer-readable storage medium having computer-executable instructions embodied thereon, wherein when executed by a profile generation computing device coupled to a payment network and having at least one processor coupled to a memory, the computer-executable instructions cause the profile generation computing device to:
receive at least one transaction record signal including records of a plurality of financial transactions processed by the payment processing network for a plurality of merchants within a predefined geographic area;
identify categories of goods purchased by a plurality of cardholders from the merchants in the predefined geographic area based on the plurality of financial transactions;
determine that a subset of the cardholders are residents of the predefined geographic area based at least in part on determining that a subset of the cardholders purchased goods from the merchants in the predefined geographic area at a frequency that is at least equal to a reference frequency;
determine an estimated average socioeconomic status of the residents based on the categories of goods; and
generate a profile of the predefined geographic area, wherein the profile includes at least the estimated average socioeconomic status of the residents.

18. The computer-readable storage medium of claim 17, wherein said computer-executable instructions further cause the profile generation computing device to:
receive a request signal from the client computing device including a request for profile information associated with the predefined geographic area; and
transmit instructions to the client computing device to display at least a portion of the profile in association with a map of the predefined geographic area.

19. The computer-readable storage medium of claim 17, wherein said computer-executable instructions further cause the profile generation computing device to determine the estimated average socioeconomic status of the residents by:
retrieving a plurality of reference socioeconomic status profiles from the memory, wherein each reference socioeconomic status profile includes reference categories of goods, and at least one of an income bracket and a list of interests;
determining a respective similarity score between the identified categories of goods purchased by the residents and the reference categories of goods associated with each reference socioeconomic status profile; and
associating the estimated average socioeconomic status with the reference socioeconomic status profile having the greatest similarity score.

20. The computer-readable storage medium of claim 17, wherein said computer-executable instructions further cause the profile generation computing device to determine at least one trend in spending associated with at least one of the plurality of merchants in the predefined geographic area.
